(19) United States
(12) Patent Application Publication
(10) Pub. No.: US 2004/0073652 A1
(43) Pub. Date: Apr. 15, 2004

(54) Dynamic IP relay method and system for providing a remote user with a current IP address of an internet connection

(76) Inventor: Craig J. Jensen, Cedar Rapids, IA (US)

Correspondence Address: SIMMONS, PERRINE, ALBRIGHT & ELLWOOD, P.L.C., THIRD FLOOR TOWER PLACE, 22 SOUTH LINN STREET, IOWA CITY, IA, 52240, US

(21) Appl. No.: 10/065,439

(22) Filed: Oct. 17, 2002

(51) Int. Cl. G06F 15/173; G06F 15/16

(52) U.S. Cl. 709/224

(57) ABSTRACT

A system and method for reporting, either automatically or manually, a dynamic IP address of an internet connection, which system and method involves a dedicated hardware device or circuit card/subsection, which is not a general purpose PC that generates and communicates over the internet such dynamic IP addresses.

### BACKGROUND OF INVENTION

In recent years, there has been a proliferation of internet users. Each of these users (i.e., a computer or other internet appliance which is communicating over the internet) must have, at the time of such communication, an IP address associated with it. The term “internet appliance” is used herein to refer to any type of device which is capable of and configured to communicate over the internet. This can, of course, include PCs, but it can also refer to a much smaller device with relatively limited applications. Since there are a finite number of IP addresses available on the internet, it is common for Internet Service Providers (ISPs) to not assign each user with a permanent IP address. Instead, IP addresses often are dynamic.

As is with the case of dial-up (phone) connections, the use of dynamic IP addresses has shortcomings. For example, if a home has numerous internet appliances, each coupled to an in-home network, which is then coupled to the internet via a cable modem, DSL modem, dial-up modem, etc., the homeowner could interrogate internet appliances, such as security cameras, heating and air conditioning systems, etc. However, before the absent homeowner can interrogate his security camera, he must know the IP address associated with that modem and camera. But if the homeowner's ISP uses dynamic IP addresses, and the address to the modem to be interrogated has changed, then the absent homeowner will be unable to remotely utilize his security system.

In view of this situation, it is very desirable to provide remote users with a current IP address for their internet appliances. One method for providing this information been to have a dedicated general purpose PC at the unattended location to report to a website the current dynamic IP address for that unattended dedicated PC. Then the remote user must query the website to obtain the information. While this approach is helpful in certain situations, it does not meet all the needs for information caused by dynamic IP addresses. For example, if the internet appliance to be interrogated remotely is not connected to a dedicated general purpose PC running a particular software program, the above-described website would be unable to provide the necessary information.

Consequently, there exists a need for an improved method and system for providing dynamic IP addresses to remote users of internet appliances.

### SUMMARY OF INVENTION

It is an object of the present invention to provide a system and method for providing dynamic IP addresses in an efficient manner.

It is a feature of the present invention to utilize a device other than a dedicated general purpose PC to report IP addresses.

It is another feature of the present invention to include a dongle or embedded circuitry into a modem, router, or other device which reports changes in dynamic IP addresses.

It is an advantage of the present invention to achieve improved efficiency in reporting changes in dynamic IP addresses which does not require the expense of a dedicated general purpose personal computer and special purpose software to do the monitoring and/or reporting.

It is another advantage of the present invention to provide a more reliable monitoring and/or reporting device which avoids some of the potential faults which are commonly associated with general purpose PCs.

The present invention is an apparatus and method for providing dynamic IP addresses of remote internet connections, designed to satisfy the aforementioned needs, provide the previously stated objects, include the above-listed features, and achieve the already articulated advantages. The present invention is carried out in a “wasted resource-less” manner in a sense that the resources wasted when a dedicated general purpose PC is used and maintained in operation to monitor and report changes in dynamic IP addresses, have been eliminated.

Accordingly, the present invention is a system and method including an electronic hardware device which reports a dynamic IP address for an internet connection, where the electronic hardware device is not a general purpose PC.

### BRIEF DESCRIPTION OF DRAWINGS

The invention may be more fully understood by reading the following description of the preferred embodiments of the invention, in conjunction with the appended drawings wherein:

FIG. 1 is a block diagram view of a system of the present invention.

FIG. 2 is an alternate embodiment of a dynamic IP address-reporting device of the present invention which utilizes an automated reporting procedure.

FIG. 3 is a simplified block diagram view of an alternate dynamic IP address-reporting device of the present invention which utilizes a manual process for the initiation of a dynamic IP address-reporting procedure.

### DETAILED DESCRIPTION

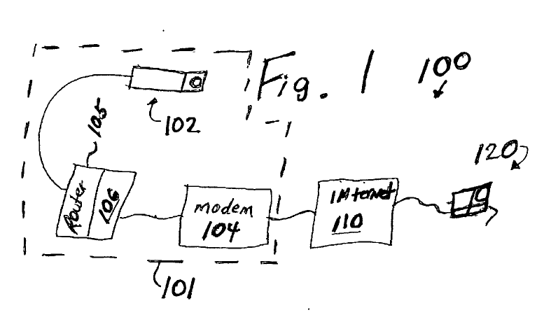

Now referring to the drawings wherein like numerals refer to like matter throughout, and more specifically referring to FIG. 1, there is shown a system of the present invention generally designated 100, including a security camera 102, or other internet appliance or internet aware system, which is coupled through a modem 104 to the internet 110. (In this case, a security camera is shown, but any TCPIP or internet aware device can be substituted.) Modem 104 is representative of any type of modem or communication device, such as a cable modem, DSL modem, network interface card for coupling to a local area network, or wide area network, a dial-up modem or other telephony connection, satellite service interface, wireless network interface, spread spectrum type modem, etc. Disposed between or in series with modem 104 or the like, and internet 110 is dynamic IP relay hardware 106, which may be combined with a router 105 or other network components.

Coupled to internet 110 is remote user PC 120. Remote user PC 120 can be any type of device which is capable of communicating via the internet and is capable of communicating with dynamic IP relay hardware 106 and security camera 102. Dynamic IP relay hardware 106 may be referred to as a dongle because in one preferred embodiment, it is a separate electronic device disposed in a path of a communication system. In other applications, it may be a circuit card within a PC, a card in a router, or integrated into any device coupled to the network.

In operation, remote user PC 120 is able to remotely interrogate security camera 102 despite a change of a dynamic IP address for said modem 104 and security camera 102 or the like. Dynamic IP relay hardware 106 can be any hardware-based circuitry which monitors communication between modem 104 and internet 110 to determine a current dynamic IP address. Dynamic IP relay hardware 106 preferably comprises a printed circuit board or a portion thereof. Dynamic IP relay hardware 106 also preferably contains a configuration utility built therein which would permit a user to configure the dynamic IP relay hardware 106, using a separate device, such as a PC with a standard browser, to notify others about changes in the dynamic IP address. The dynamic IP relay hardware 106 could be configurable to provide notices in various ways, such as e-mail, pages, telephone calls, data transferred to a website, etc. Once the dynamic IP relay hardware 106 is configured, the configuration data is preferably stored in non-volatile memory therein, so that the dynamic IP relay hardware 106 needs no further attention until the user desires a change in the configuration.

It should be understood that modem 104 or router 105 or the like could be integrated with dynamic IP relay hardware 106 to form a single unit, such as embedded on a single printed circuit card. It should also be understood that the dynamic IP relay hardware need not monitor for changes in IP addresses. In some cases, it is sufficient to merely report recent IP addresses; but in any case, if the IP address changes, the dynamic IP relay hardware 106 will report it if it is so programmed by the user.

Now referring to FIG. 2, there is shown a simplified block diagram of the dynamic IP relay hardware 106 of FIG. 1. Dynamic IP relay hardware 106 includes a printed circuit board 200 or the like, which has an input 202 for a broadband or other internet connection, such as cable, DSL, satellite, etc. Dynamic IP relay hardware 106 may, in addition or alternatively, include a telephone input 204 which is coupled to hardware/software for a dial-up connection 212. Input 202 and dial-up connection 212 are coupled to a microprocessor 216 which is coupled to an EPROM 214, or the like. Monitor software 210 is coupled to microprocessor 216. Port 206 for local devices is shown, but is not essential for all implementations. Monitor software could be an independent EPROM or the like, or it could be disposed within EPROM 214. Microprocessor 216, together with monitor software 210, can monitor the current IP address associated with either input 202 or 204. With input 202, the monitoring for IP addresses may be done periodically or in response to an occurrence of an event. Monitor software 210 could detect an IP address whenever a dial-up connection is made. The information about the current IP address for a particular connection could then be communicated back out that particular connection and on to the internet. Configuration software 218 which can be configured via a port 208 can determine the nature of the report of the IP address. For example, configuration software 218 might be configured to send e-mails to a list of recipients, go to a website and provide the IP address there, or any type of communication capable of disseminating the IP address information. Dynamic IP relay hardware 106 may also have an independent internet or network output port 206 for conveying such IP address information.

In operation, the dial-up connection 212 of the present invention could function as follows: a remote user 120 wishing to access a security camera 102 makes a telephone call to the dynamic IP relay hardware 106. Dial-up connection 212 answers the incoming call and in response to the call, initiates a dial-up connection to the internet via telephone input 204 (after incoming call has been terminated). As discussed above, the IP address would automatically be sent out via the internet. For enhanced security, the dial-up connection is established only after confirmation of the caller's authority to cause such actions. Dial-up connection 212 could listen for DTMF tones which correspond to a predetermined code; it can match caller ID information to pre-approved caller ID information; or it could activate upon answering, but only after a large number of rings, e.g. 20 rings. A typical web browser could be used as an interface in this application.

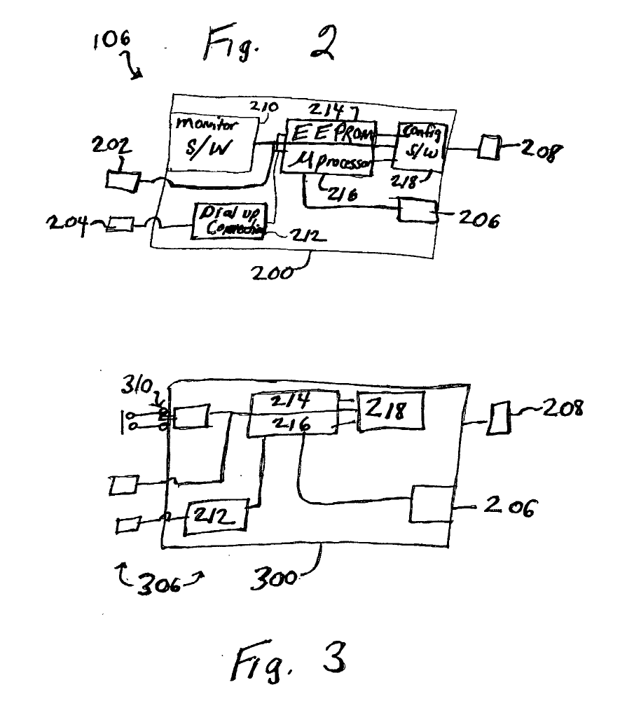

Now referring to FIG. 3, there is shown an alternate embodiment of the dynamic IP relay hardware 106 of FIGS. 1 and 2, generally designated 300. The dynamic IP address relay 306 includes an exterior contact closure 310 which can be actuated by a security device to produce a report of the then current dynamic IP address. This embodiment of the present invention is especially useful for security systems where it might be important to have the IP address available when the contact is closed, such as during a robbery, or at the time of a burglary when a door or window is opened, or when some environment sensor in a home is actuated, such as when a flood occurs and a float is raised. Many other uses for a mechanical or contact closure or electrical switch 310 are envisioned as well. e.g. A push button could be connected and used to test the system before leaving the home.

Throughout this description, reference is made to stand-alone electronic hardware because it is believed that the beneficial aspects of the present invention would be most readily apparent when used in connection with a stand-alone electronic hardware device disposed in a communication path of a communication network. However, it should be understood that the present invention is not intended to be limited to stand-alone independent hardware devices and should be hereby construed to include other embedded hardware and software designs as well.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

1. A system for remotely accessing an internet connection having a dynamic IP address, the system comprising:
an internet appliance coupled to an internet connection;
a dynamic IP relay hardware device coupled with said internet appliance and said internet connection;
said device being configured to report to a remote user, via said internet connection, a dynamic IP address associated with said internet connection; and,
said dynamic IP relay hardware is not a general purpose personal computer.

2. A system of claim 1 wherein said dynamic IP relay hardware comprises a microprocessor and software executed by said microprocessor which, in combination, are configured to generate a report of an IP address for said internet connection in response to an occurrence of a predetermined event.

3. A system of claim 2 wherein said predetermined event comprises a passage of a predetermined amount of time.

4. A system of claim 2 wherein said predetermined event comprises a determination, at least in part, by monitoring software, that a dynamic IP address for said internet connection has been changed.

5. A system of claim 2 wherein said report is configurable in response to a particular configuration state of configuration software executed by said microprocessor.

6. A system of claim 5 wherein said configuration software is configured to provide for configuration thereof by a device external to said dynamic IP relay hardware device.

7. A system of claim 2 wherein said dynamic IP relay hardware device comprises a printed circuit board disposed in a case housing other electronic hardware coupled to a computer network.

8. A system of claim 2 wherein said microprocessor assists in initiating a dial-up internet connection in response to an incoming telephone call.

9. A system of claim 8 wherein a security procedure is completed prior to initiating said dial-up internet connection.

10. A system of claim 9 wherein said security procedure comprises matching incoming information with predetermined information.

11. A system of claim 10 wherein said incoming information comprises a series of DTMF tones.

12. A system of claim 10 wherein said incoming information comprises caller ID information.

13. A system of claim 12 wherein said dynamic IP relay hardware device comprises a stand-alone device which is not completely housed within a case containing a modem.

14. A system of claim 12 wherein said dynamic IP relay hardware device comprises a stand-alone device which is not completely housed within a case containing a router.

15. A method of remotely accessing an internet appliance comprising the steps of:
providing an electronic hardware device which is not a general purpose personal computer;
using said electronic hardware device to generate a report of an IP address for an internet connection, in response to an occurrence of a predetermined event;
using said electronic hardware device to communicate said report to a remote user via said internet connection; and
using said IP address to remotely access said internet connection.

16. A method of claim 15 further comprising the step of:
determining if a change in IP-address has occurred with respect to said internet connection.

17. A method of claim 15 wherein said report comprises an e-mail.

18. A method of claim 17 further comprising the steps of:
answering an incoming telephone call;
receiving incoming authorization information during said incoming telephone call;
matching said incoming authorization information to predetermined authorization information;
initiating a dial-up connection in response to said step of matching said incoming authorization information to predetermined authorization information; and
wherein said dial-up connection comprises said internet connection.

19. A method of claim 18 further comprising the steps of:
configuring said report via a personal computer coupled to said electronic hardware device.

20. A system for accessing information from an unattended internet appliance via an internet connection having dynamic IP addresses comprising:
an unattended internet appliance;
a telephone modem disposed between and interconnecting said unattended internet appliance with a remote user via a dial-up internet connection;
a stand-alone electronic hardware device which is not a general purpose personal computer and which is further not disposed in a case with a device which is configured for communicating information across a computer network;
said stand-alone electronic hardware device comprising a microprocessor and memory which is configured to store software therein which is executed by said microprocessor;
said stand-alone electronic hardware device being configured to receive report configuration commands from an external personal computer;
said microprocessor and said software together configured to initiate said dialup internet connection in response to an incoming telephone call which authorizes said dial-up internet connection only after incoming information is matched to predetermined authorization information; and,
said microprocessor and said software together further configured to generate an e-mail report indicating a current IP address for said dial-up internet connection, where said e-mail report is in response to said report configuration commands.

21. A method of testing a configuration of an internet appliance comprising the steps of:
providing an electronic hardware device which is not a general purpose personal computer;
using said electronic hardware device to generate a report of an IP address for an internet connection, in response to an occurrence of a predetermined event;
using said electronic hardware device to communicate said report to a remote user via said internet connection; and
using said IP address to test a configuration.

22. A system for remotely accessing an internet connection having a dynamic IP address, the system comprising:
a dynamic IP relay hardware device coupled to said internet connection;
a device being configured to report to a remote user, via said internet connection, a dynamic IP address associated with said internet connection; and,
said dynamic IP relay hardware is not a general purpose personal computer.

23. A system of claim 22 wherein said dynamic IP relay hardware comprises a microprocessor and software executed by said microprocessor which, in combination, are configured to generate a report of an IP address for said internet connection in response to an occurrence of a predetermined event.
